(19) United States
(12) Patent Application Publication
(10) Pub. No.: US 2020/0039617 A1
(43) Pub. Date: Feb. 6, 2020

(54) Underwater mask

(71) Applicant: Mares S.p.A., Rapallo (GE) (IT)

(72) Inventors: Christof Oelrich, Chiavari (GE) (IT); Sergio Angelini, Lavagna (GE) (IT)

(21) Appl. No.: 16/524,120

(22) Filed: Jul. 28, 2019

(30) Foreign Application Priority Data
Aug. 6, 2018 (IT) 102018000007879

(51) Int. Cl. B63C 11/12; B32B 27/08; C08L 25/08

(52) U.S. Cl. CPC B63C 11/12; C08L 2201/10; C08L 25/08; B32B 27/08

(57) ABSTRACT

A diving mask includes a facial body and at least one transparent element which enables viewing and is adapted to overlap the eye area, made by co-molding at least two different thermoplastic elastomers, the transparent element being made from a thermoplastic elastomer provided with a relatively greater degree of hardness, the facial body being made from a thermoplastic elastomer provided with a relatively lower degree of hardness.

### FIELD OF THE INVENTION

The present invention concerns equipment for swimming and water sports, and especially concerns a diving mask.

### BACKGROUND OF THE INVENTION

The diving masks currently on the market are generally constituted by a facial body made of material adapted to sealingly adhere to the face of the user, generally made of elastomeric material which is often of the silicone type, provided with one or two openings to house, respectively, one or two transparent elements through which the user is allowed to see, and able to achieve the seal around the same in cooperation with a stiff frame generally made of thermoplastic material such as Nylon, polycarbonate, polypropylene or the like; the mask is placed on the head of the user thanks to a strap, which is usually made of the same material as that of the facial body of the mask.

If, on one hand, the transparent element, usually made of tempered glass, offers the best guarantees in terms of stiffness and transparency, it makes this type of equipment susceptible to sealing problems in the respective seats on the other, in addition to the decidedly considerable manufacturing costs and to the problems related to the fragility and weight of the material.

Since the pressure must always be compensated, i.e. equal between the outside and inside of the mask, to prevent the eyes from coming out of their sockets, the resistance to pressure is not a critical factor, whereas some stiffness is useful in avoiding deformations, for example by pulling the strap which fixes the mask to the head. In the absence of sufficient stiffness, the deformations of the transparent element or a divergence between the two transparent elements with respect to one another would cause image deformations which would confuse sight. Moreover, the processing steps for manufacturing diving masks of this type substantially provide three different paths for the four components, given that the facial body and the strap can also be made in the same mold, and thus one assembling step.

In order to achieve a diving mask of simplified structure and construction, and thus with lower manufacturing costs, and which ensures good visibility and an effective seal on the face of the user, a mask, made in one piece by using a unique material molded with different thicknesses, was suggested in document IT1343719, with the aim to achieve both transparent elements with an appropriate degree of transparency and a facial body able to interact properly with the face of the user.

Aside from the considerations of theoretical nature with regard to the efficacy of this solution, there really are few materials which allow, depending on the thickness used, to achieve the adequate flexibility necessary for the peripheral seal of the facial body and the adequate stiffness to allow a non-deformed and clear vision through the transparent elements. In the document, it seems that a preferential solution is the one which uses a platinic silicone, which is a material with optimal qualities in terms of the interactions with the user, given it is approved for food use and decidedly resistant to aging and aggressive chemicals, but also particularly soft (Shore A hardness 30-70). Consequently, although very appropriate for making the facial body of the mask, it doesn't seem much suitable for making the transparent elements. The other preferable plastic material reported in the document mentioned is PVC (polyvinylchloride), which, however, is chemically less inert than silicone rubber and relatively harder (in the order of Shore A 65 with the use of plasticizers); these characteristics thus make it more appropriate for making the transparent elements, but less appropriate for making the facial body of the mask. Moreover, the general trend is to use less PVC for various reasons.

### SUMMARY OF THE INVENTION

Object of the present invention is thus to provide a diving mask of simple and economic production that is simultaneously able to provide optimal performances both in terms of the efficiency of the transparent elements and of the comfort and functionalities of the facial body and that is also less delicate in terms of possible damages and that can withstand high elastic deformations during its transport without losing the functional technical characteristics.

Object of the present invention is thus a diving mask, comprising a facial body and at least one transparent element, made by co-molding at least two different thermoplastic elastomers, said transparent element being formed by a thermoplastic elastomer provided with a relatively greater degree of hardness, and said facial body being formed by a thermoplastic elastomer provided with a relatively lower degree of hardness than that of the transparent element.

In a preferred embodiment, the thermoplastic elastomer forming said transparent element, or said transparent elements, of the mask has Shore A hardness between 75 and 95, and preferably 85, whereas the thermoplastic elastomer forming the facial body of the mask has Shore A hardness between 35 and 55, and preferably 45 or Shore D between 30 and 65, preferably 45.

Advantageously, said thermoplastic elastomers are both copolymers of styrene, and in particular styrene/ethene-butene/styrene or styrene/ethylene/butyl/styrene copolymers.

In a further embodiment of the invention, said diving mask further comprises a relatively stiffer frame, also co-molded with the transparent element(s) and the facial body, which frame is made of thermoplastic elastomer provided with Shore D hardness between 50 and 70, and preferably 60.

In an embodiment, such thermoplastic elastomer is olefinic, such as a co-polymer of ethylene/propylene/propylene, polypropylene or a combination of polymers and polyolefin copolymers or else it is constituted by polycarbonate or nylon or combinations of these materials when compatible with each other.

In an embodiment variant, said frame is made between said transparent element, or said transparent elements, and said facial body.

Alternatively, the frame is co-molded on both said facial body and said transparent element, or said transparent elements, directly coupled to each other.

It will be clear to the expert of the art how the mask according to the present invention can also provide more than two transparent elements, such as for example occurs in the panoramic masks made according to the known art, in which a further transparent element is provided for each eye in the area of the mask body facing the mouth and/or in the area of the mask body facing the forehead and/or in the two side areas facing the ears, it being possible to provide any combination of said further transparent elements in any number and arrangement.

In alternative or in combination with one or more of the embodiments described, it is also possible to make the only transparent element or the two transparent elements each associated with an eye in the form of a cup or polygonal half-shell, such as for example is known in swimming goggles and described in the patent application EP3194034 having the same owner.

In this case, the edges of the polygonal half-shell transparent element would give stiffness and could at least in part prevent, also for the mask with two transparent elements each associated to viewing with a respective eye, i.e. with two transparent elements, the overmolding of a whole frame with a third material. This frame could thus alternatively extend for at least part of the peripheral edges of the transparent elements and not for their entire extension and be at least for some parts of the same material as that of the mask body perhaps provided with greater material thicknesses in at least some areas.

Further alternatives can consist in a combination of these variants constituted by a reinforcing frame made of a third material extending for a certain length of the shape of the transparent element(s), a part of the mask body of greater thickness in the adhering area and at least one part of the peripheral edge of the transparent element(s), which are provided in a coincident position, partially coincident and/or non-coincident with the segments of said frame and folding edges of the transparent element, which extend at least in some areas of this/these transparent element(s) also in coincident position, partially coincident and/or non-coincident with the areas in which the segments of said frame are provided and/or with the thicker areas of the mask body.

The definition of such combinations depends on the shape of the mask, on the use for which it is intended and can be defined, based on experience, in the context of simple design activities by the expert of the art.

### BRIEF DESCRIPTION OF THE DRAWINGS

Further advantages and characteristics of the diving mask according to the present invention will become clearer in the following description of some embodiments thereof, made by way of example and without limitations, with reference to the accompanying tables of drawings, in which:

FIG. 1 is a perspective view of a first embodiment of the diving mask according to the present invention;

FIG. 2 is a perspective view with parts in longitudinal section of the mask of FIG. 1;

FIG. 3 is a perspective view with parts in cross section of the mask of FIG. 1;

FIG. 4 is a perspective view of a second embodiment of the diving mask according to the present invention;

FIG. 5 is a perspective view with parts in longitudinal section of the mask of FIG. 4;

FIG. 6 is a perspective view with parts in cross section of the mask of FIG. 4;

FIG. 7 is a perspective view with parts in cross section of an embodiment variant of the mask according to the present invention; and

FIG. 8 is a perspective view with parts in longitudinal section of the mask of FIG. 7.

### DETAILED DESCRIPTION OF EMBODIMENTS OF THE INVENTION

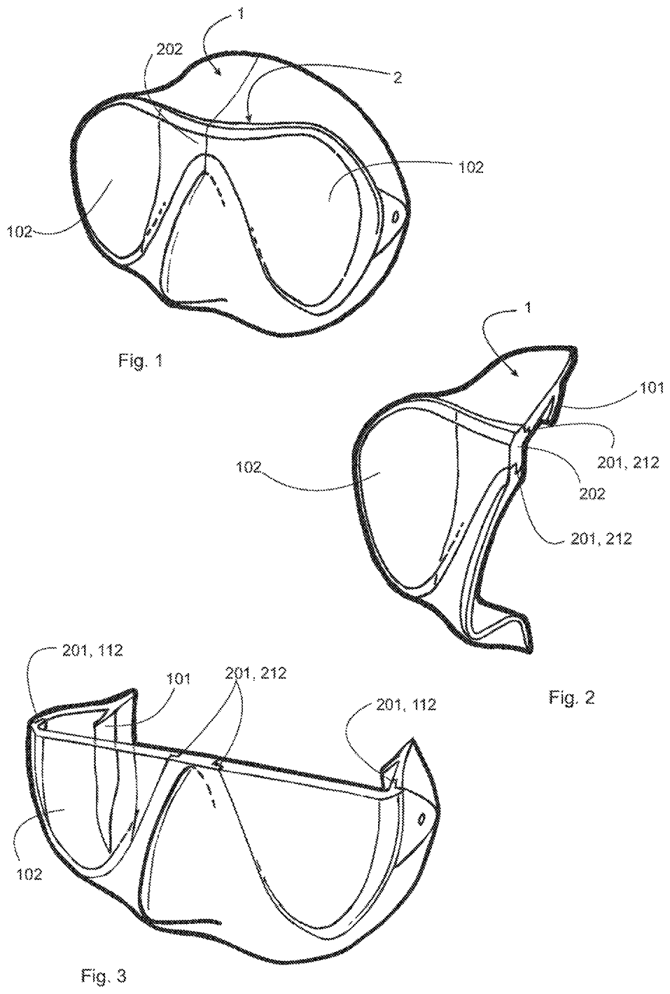

A first embodiment of the diving mask according to the present invention is shown in FIG. 1; 1 denotes the facial body of the mask, whereas 2 denotes a unique transparent element, formed by the two lobes 102 and by the bridge 202 and which extends such as to overlap with the area of the two eyes of the user. In FIG. 2, the mask is shown with parts in longitudinal section, and it is possible to distinguish the lip 101 of the facial body 1, intended to exert the seal on the face of the user, as well as the contact surfaces between the peripheral edge 201 of the body 1 and the peripheral edge 212 of the bridge 202 of the transparent element 2 can be seen. In FIG. 3, where equal parts correspond to equal numbers, the contact surfaces between the peripheral edge 201 of the body 1 and the peripheral edge 112 of the lobes 102 of the transparent element 2 are also shown.

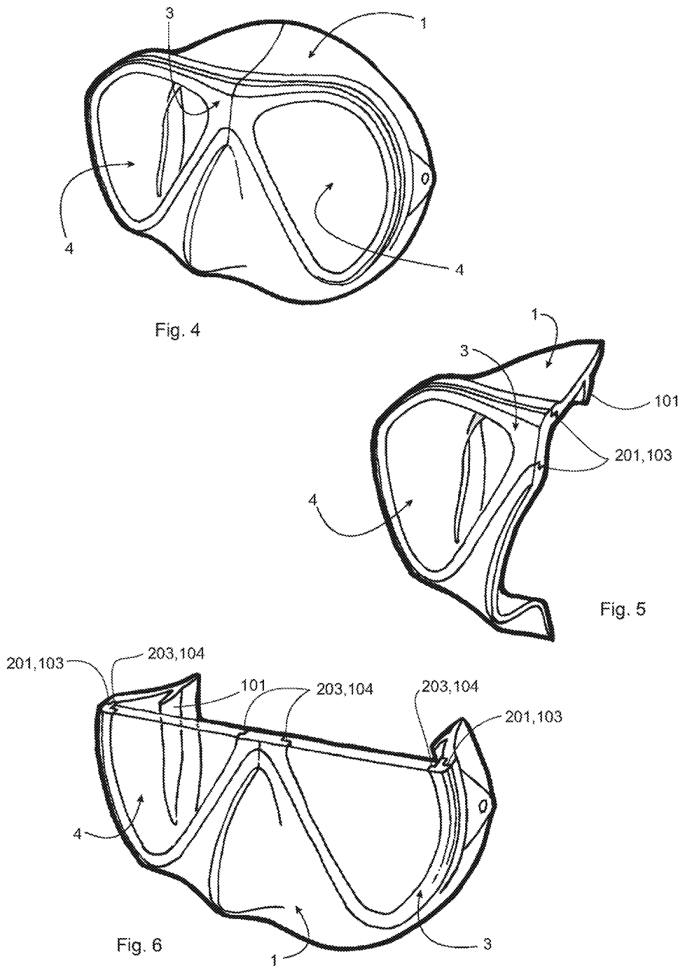

A second embodiment of the mask of the invention is shown in FIG. 4; 1 denotes the facial body of the mask again, which has, in this case, the frame 3 and a couple of transparent elements 4 independent of one another and essentially coincident with the area of respectively one of the two eyes. The mask with parts in longitudinal section is shown in FIG. 5, and the contact surfaces between the peripheral edge 201 of the body 1 and the peripheral edge 103 of the frame 3 are shown in addition to the lip 101 of the body 1. In FIG. 6, in which equal parts correspond to equal numbers, the contact surfaces between the inner edge 203 of the frame 3 and the peripheral edge 104 of the transparent elements 4 are also shown.

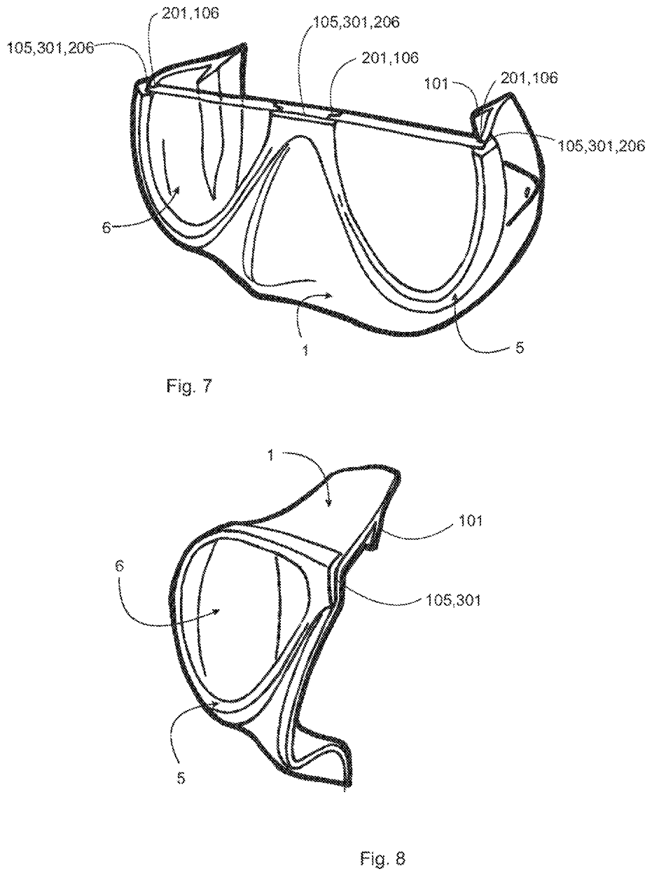

In the variant shown in FIG. 7, the crystal glasses 6 have the contact surfaces 106 with the peripheral edge 201 of the body 1, in addition to the contact surfaces 206 with the inner edge 105 of the frame 5. Said edge 105 of the frame 5 is further in contact with the surface 301 of the facial body 1; the contact between the surface 301 of the facial body 1 and the edge 105 of the frame 5 in the area between the two transparent elements 6 is highlighted in FIG. 8.

The structure of the mask according to the present invention will become clearer hereunder. In the embodiment of FIGS. 1 to 3, a mask made by co-molding two thermoplastic elastomer materials, suitable for this type of process and which are easily coupled to each other, is shown. The thermoplastic elastomer used to make the unique transparent element 2 is preferably provided with a Shore A stiffness degree between 75 and 95, and more preferably in the order of 85. This way, the unique transparent element 2 is able to impart sufficient stiffness to the structure of the mask so that to prevent deformations in the sight of the user or problems related to the wearability thereof. The facial body 1 is made with a thermoplastic elastomer provided with a decidedly lower Shore A stiffness degree, between 35 and 55, and preferably 45, so that to allow the facial body itself, and especially the lip 101, to better adhere to the face of the user. Among the thermoplastic elastomers, there can preferably be the copolymers of styrene, and in particular the so-named SEBS, i.e. styrene/ethene-butene/styrene or styrene/ethylene/butyl/styrene copolymers.

By using only two materials, it is substantially necessary to select the unique transparent element for both eyes.

By using two transparent elements, such as in the case of biocular mask of FIGS. 4 to 6, in combination with the aforesaid only two materials for the transparent elements and the mask body, the difference between the stiffness of the transparent element and that of the facial body would tend to make the two transparent elements diverge, especially when exerting strain on the strap. In order to avoid this drawback, a mask was conceived, in which there is provided a further component, also co-molded, using an even stiffer thermoplastic elastomer with respect to the one of the glasses.

In the embodiment shown in FIGS. 4 to 6, a frame 3, which accommodates the transparent elements 4 inside it, is used, whereas it cooperates with the facial body 1 on the outside. This way, the two transparent elements are adequately supported, and their focal plane, as well as the facial body of the mask, do not suffer deformations, also when subjected to the pulling of the strap. The thermoplastic elastomer used for the frame has a Shore D stiffness degree between 50 and 70, and preferably in the order of 60; among the thermoplastic elastomers, the olefinic ones are preferred, and especially the co-polymers, for example ethylene/propylene/propylene terpolymers.

In the embodiment variant of FIGS. 7 and 8, in this case, the frame 5, which can be made of the same material as the one described for the frame 3, does not act as a link for the connection between the transparent elements 6 and the facial body 1, but provides its stiffening support outside of the aforesaid body of transparent elements.

In general, the use of different thermoplastic materials allows to better regulate the characteristics of the different areas of the mask with respect to the needs of the user; with the solution adopted according to the present invention, the sealing lip 101 is able, thanks to the intrinsic properties of the thermoplastic elastomer used, to better adhere to the face of the user, whereas the transparent elements are instead sufficiently stiff to provide an effective view; the frame provides further stiffness to the assembly.

According to a further embodiment, the frame made of the further third thermoplastic elastomer can also possibly be provided in the case of the mask according to FIGS. 1 to 3, in which the transparent element is made in one piece and unique for both eyes.

Moreover, the thermoplastic elastomers are generally devoid of problems in terms of the fogging inside the mask, a characteristic which clearly differentiates them from silicone rubber.

This way, the mask conceived combines manufacturing simplicity and savings with optimal characteristics of wearability and visibility.

The invention claimed is:

1. A diving mask, comprising:
a facial body; and
at least one transparent element through which vision by a user takes place, made by co-molding at least two different thermoplastic elastomers,
the at least one transparent element being made from a thermoplastic elastomer provided with a relatively greater degree of hardness, and
the facial body being made from a thermoplastic elastomer provided with a relatively lower degree of hardness with respect to that of the at least one transparent element.

2. The diving mask according to claim 1, wherein the thermoplastic elastomer forming the at least one transparent element has a Shore A hardness between 75 and 95, and wherein the thermoplastic elastomer forming the facial body of the mask has a Shore A hardness between 35 and 55.

3. The diving mask according to claim 2, wherein the thermoplastic elastomer of the at least one transparent element has a Shore A hardness of 85, and the thermoplastic elastomer of the facial body has a Shore A hardness of 45.

4. The diving mask according to claim 2, wherein the thermoplastic elastomers are both styrene copolymers.

5. The diving mask according to claim 4, wherein the thermoplastic elastomers are both styrene/ethene-butene/styrene or styrene/ethylene/butyl/styrene copolymers.

6. The diving mask according claim 1, further comprising a relatively stiffer frame also co-molded with the at least one transparent element and/or with the at least two transparent elements and the facial body, the frame being made from a thermoplastic elastomer with a Shore D hardness between 50 and 70.

7. The diving mask according claim 1, wherein the thermoplastic elastomer of the frame has a Shore D hardness of 60.

8. The diving mask according to claim 6, wherein the thermoplastic elastomer of the frame is olefinic, a co-polymer of ethylene/propylene/propylene polypropylene, or a combination of polymers and polyolefin copolymers, or wherein the thermoplastic elastomer of the frame is polycarbonate or nylon or combinations of these materials when compatible with each other.

9. The diving mask according to claim 6, wherein the frame is produced between the at least one transparent element and the facial body.

10. The diving mask according to claim 6, wherein the frame is co-molded on both the facial body and the at least one transparent element that are directly coupled to each other.
